(19) United States
(12) Patent Application Publication
(10) Pub. No.: US 2009/0083823 A1
(43) Pub. Date: Mar. 26, 2009

(54) ANTENNA SWITCH AND TUNER APPARATUS

(76) Inventor: Norihisa INA, Tokyo (JP)

Correspondence Address: FROMMER LAWRENCE & HAUG LLP, 745 FIFTH AVENUE, NEW YORK, NY, 10151, US

(21) Appl. No.: 12/235,883

(22) Filed: Sep. 23, 2008

(30) Foreign Application Priority Data
Sep. 25, 2007 (JP) 2007-247925

(51) Int. Cl. H04N 7/16

(52) U.S. Cl. 725/149

(57) ABSTRACT

An antenna switch including: a first input terminal that receives a terrestrial television broadcast signal as input; a second input terminal that receives a community antenna television broadcast signal as input; an output terminal that outputs the terrestrial television broadcast signal and the community antenna television broadcast signal; a signal selector switch that switches connection to either between the first input terminal and the output terminal or between the second input terminal and the output terminal in accordance with a switch select signal supplied from a predetermined control unit; and an amplifier that amplifies the terrestrial television broadcast signal and is interposed between the first input terminal and the signal selector switch.

### CROSS REFERENCES TO RELATED APPLICATIONS

The present invention contains subject matter related to Japanese Patent Application JP2007-247925 filed in the Japanese Patent Office on Sep. 25, 2007, the entire contents of which being incorporated herein by reference.

### BACKGROUND OF THE INVENTION

1. Field of the Invention

The present invention relates to an antenna switch and a tuner apparatus, and is suitably applied, for example, to the feeding of a terrestrial television broadcast signal and a community antenna television broadcast signal to a tuner of a television set.

2. Description of the Related Art

Among conventional variable gain circuits is one having a low noise amplifier and a low distortion attenuator which are interposed in parallel between an input terminal and an output terminal, the feeding to the amplifier being turned on or off depending on the input level of a signal that is input through the input terminal (for example, see Jpn. Pat. Appln. Laid-Open Publication No. 2005-217887).

When an antenna switch using this variable gain circuit feeds a tuner of a television set, for example, with a terrestrial television broadcast signal having a low input level, the terrestrial television broadcast signal can be amplified by the low noise amplifier to a predetermined level so that a terrestrial television broadcast signal having low noise can be fed to the tuner.

When the antenna switch feeds the tuner with a community antenna television broadcast signal having a high input level, the community antennal television broadcast signal can be attenuated by the low distortion attenuator so that a community antennal television broadcast signal having low distortion can be fed to the tuner.

### SUMMARY OF THE INVENTION

The antenna switch of the foregoing configuration has a problem of poor usability since it only has one input terminal and can thus create a situation that requires the connection be switched to either one of the terrestrial television broadcast signal and the community antenna television broadcast signal.

The present invention has been achieved in view of the foregoing, and is intended to propose an antenna switch and a tuner apparatus which allow improved usability, requiring no switching operation.

To solve the foregoing problem, an antenna switch according to an aspect of the present invention includes: a first input terminal that receives a terrestrial television broadcast signal as input; a second input terminal that receives a community antenna television broadcast signal as input; an output terminal that outputs the terrestrial television broadcast signal and the community antenna television broadcast signal; a signal selector switch that switches connection to either between the first input terminal and the output terminal or between the second input terminal and the output terminal in accordance with a switch select signal supplied from a predetermined control unit; and an amplifier that amplifies the terrestrial television broadcast signal and is interposed between the first input terminal and the signal selector switch, or an attenuator that attenuates the community antenna television broadcast signal and is interposed between the second input terminal and the signal selector switch.

This makes it possible to feed a terrestrial television broadcast signal having low noise or a community antenna television broadcast signal having low distortion to the tuner by only having the user determine which to select, the terrestrial television broadcast signal or the community antenna television broadcast signal, without troublesome switching operations.

A tuner apparatus according to another aspect of the present invention has an antenna switch and a television tuner unit. The antenna switch includes: a first input terminal that receives a terrestrial television broadcast signal as input; a second input terminal that receives a community antenna television broadcast signal as input; an output terminal that outputs the terrestrial television broadcast signal and the community antenna television broadcast signal; a signal selector switch that switches connection to either between the first input terminal and the output terminal or between the second input terminal and the output terminal in accordance with a switch select signal supplied from a predetermined control unit; and an amplifier that amplifies the terrestrial television broadcast signal and is interposed between the first input terminal and the signal selector switch or an attenuator that attenuates the community antenna television broadcast signal and is interposed between the second input terminal and the signal selector switch. The television tuner unit includes: a television tuner that has an input terminal to which the terrestrial television broadcast signal and the community antenna television broadcast signal are input from the antenna switch; a control unit that supplies the switch select signal to the signal selector switch of the antenna switch; and a demodulation unit that demodulates the terrestrial television broadcast signal and the community antenna television broadcast signal fed from the television tuner.

This makes it possible to feed a terrestrial television broadcast signal having low noise or a community antenna television broadcast signal having low distortion to the tuner by only having the user determine which to select, the terrestrial television broadcast signal or the community antenna television broadcast signal, without troublesome switching operations.

According to the present invention, it is possible to feed a terrestrial television broadcast signal having low noise or a community antenna television broadcast signal having low distortion to the tuner by only having the user determine which to select, the terrestrial television broadcast signal or the community antenna television broadcast signal, without troublesome switching operations. An antenna switch and a tuner apparatus of improved usability can thus be achieved, requiring no switching operations.

### BRIEF DESCRIPTION OF THE DRAWINGS

FIG. 1 is a schematic diagram showing the overall configuration of a tuner apparatus;

FIG. 2 is a schematic diagram showing the circuit configuration of the tuner apparatus;

FIG. 3 is a schematic diagram showing how a low noise AGC amplifier is connected;

FIG. 4 is a schematic diagram showing how a low distortion attenuator is connected;

FIG. 5 is a schematic diagram showing the circuit configuration of the low noise AGC amplifier;

FIG. 6 is a schematic diagram showing noise figure and distortion after a signal is amplified by the low noise AGC amplifier;

FIG. 7 is a schematic diagram showing the circuit configuration of the low distortion attenuator;

FIG. 8 is a schematic diagram showing noise figure and distortion after a signal is attenuated by the low distortion attenuator;

FIG. 9 is a schematic diagram showing an antenna switch according to other embodiments; and

FIG. 10 is a schematic diagram showing an antenna switch according to yet other embodiments.

### DETAILED DESCRIPTION OF THE PREFERRED EMBODIMENTS

Hereinafter, an embodiment of the present invention will be described in detail with reference to the drawings.

### (1) Configuration of Tuner Apparatus

### (1-1) Overall Configuration of Tuner Apparatus

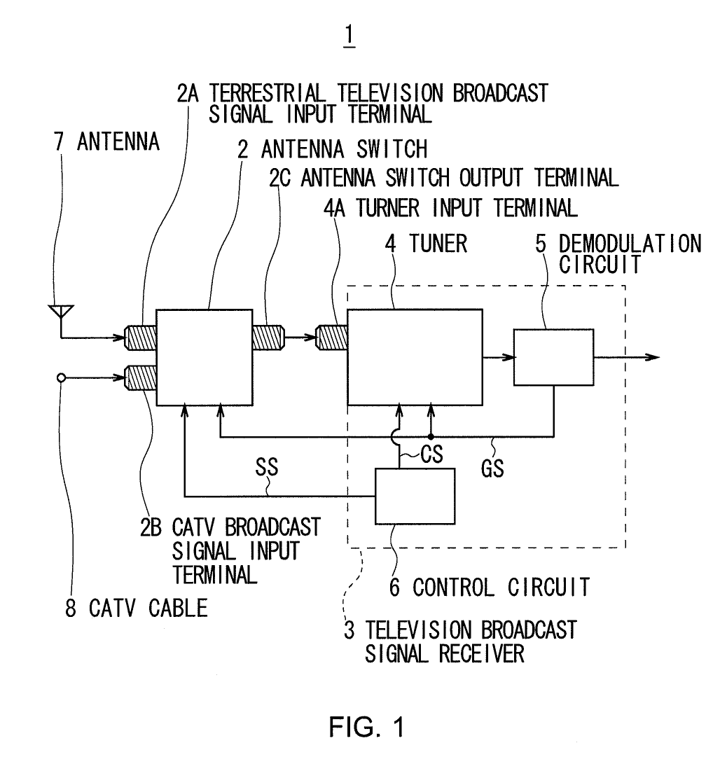

FIG. 1 shows a tuner apparatus 1 as a whole. The tuner apparatus 1 includes an antenna switch 2 and a television broadcast signal receiver 3.

The antenna switch 2 is formed separately from the television broadcast signal receiver 3. The antenna switch 2 has: a terrestrial television broadcast signal input terminal 2A for inputting a terrestrial television broadcast signal which is received by an antenna 7; a community antenna television (hereinafter, referred to as CATV) broadcast signal input terminal 2B for inputting a CATV broadcast signal which is fed through a CATV cable 8; and an antenna switch output terminal 2C for outputting the terrestrial television broadcast signal or the CATV broadcast signal.

The antenna switch 2 can output either one of the terrestrial television broadcast signal input through the terrestrial television broadcast signal input terminal 2A and the CATV broadcast signal input through the CATV broadcast signal input terminal 2B to the television broadcast signal receiver 3 through the antenna switch output terminal 2C, thereby feeding the television broadcast signal receiver 3 with the terrestrial television broadcast signal or the CATV broadcast signal.

The television broadcast signal receiver 3 includes a tuner 4, a demodulation circuit 5, and a control circuit 6. The tuner 4 of the television broadcast signal receiver 3 is an existing model, having no additional functions as compared to heretofore.

The tuner 4 of the television broadcast signal receiver 3 inputs the terrestrial television broadcast signal or the CATV broadcast signal supplied from the antenna switch output terminal 2C of the antenna switch 2 through the tuner input terminal 4A.

The tuner 4 then performs frequency conversion on the terrestrial television broadcast signal or the CATV broadcast signal, and transmits the resulting intermediate frequency (IF) signal to the demodulation circuit 5.

The demodulation circuit 5 demodulates the IF signal fed from the tuner 4 into a video signal and a sound signal, and transmits the video signal to a video display unit (not shown) and the sound signal to a sound output unit (not shown).

Based on the voltage level of the IF signal, the demodulation circuit 5 also transmits auto gain control (AGC) signals GS for adjusting this IF signal to a constant voltage level to the antenna switch 2 and the tuner 4.

When a broadcast select signal SS for selecting either a terrestrial television broadcast or a CATV broadcast is supplied to the control circuit 6 from a remote control (not shown), for example, in response to a user's remote control operation, the control circuit 6 transmits the broadcast select signal SS to the antenna switch 2.

When a channel select signal CS for selecting a channel is supplied to the control circuit 6 from the remote control in response to a user's remote control operation after the selection of either one of a terrestrial television broadcast and a CATV broadcast, the control circuit 6 also transmits the channel select signal CS to the tuner 4.

### (1-2) Circuit Configuration of Tuner Apparatus

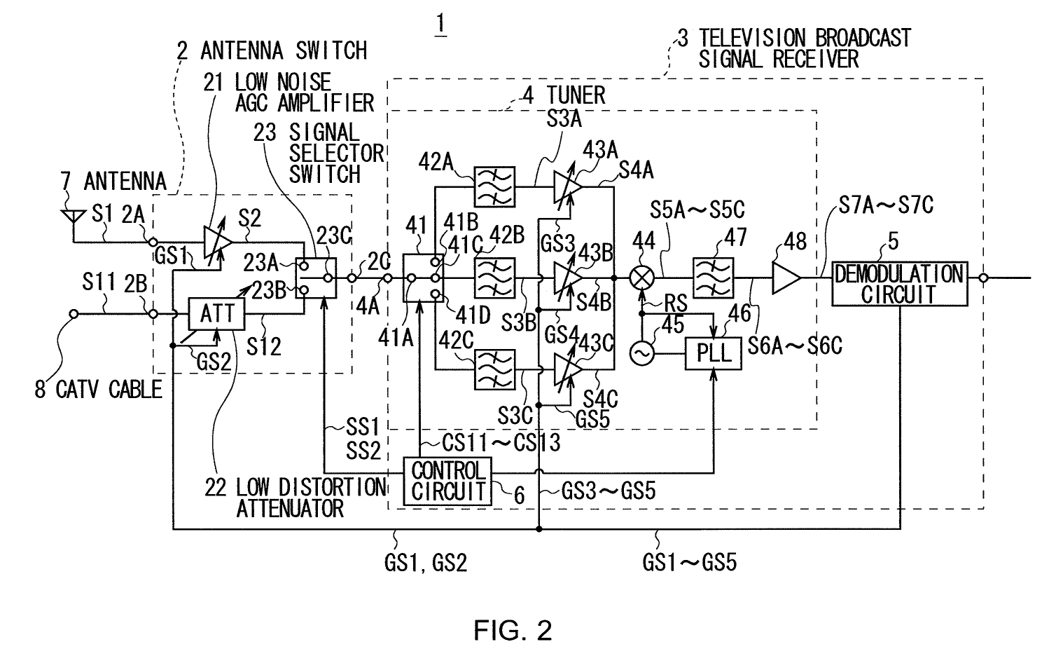

Now, the tuner apparatus discussed above will be described in more detail. As shown in FIG. 2, the antenna switch 2 is composed of a low noise AGC amplifier 21, a low distortion attenuator 22, and a signal selector switch 23.

The tuner 4 is composed of a band selector switch 41, tracking filters 42A to 42C, RF amplifiers 43A to 43C, a mixer 44, a local oscillator 45, a phase lock loop (PLL) circuit 46, an IF filter 47, and an IF amplifier 48.

When a terrestrial television broadcast signal S1 received by the antenna 7 is input through the terrestrial television broadcast signal input terminal 2A, the antenna switch 2 transmits the terrestrial television broadcast signal S1 to the low noise AGC amplifier 21.

The low noise AGC amplifier 21 amplifies the terrestrial television broadcast signal S1 in accordance with an AGC control signal GS1 which is supplied from the demodulation circuit 5, and transmits the resulting terrestrial television broadcast signal S2 to an input terminal 23A of the signal selector switch 23.

When a CATV broadcast signal S11 transmitted through the CATV cable 8 is input through the CATV broadcast signal input terminal 2B, on the other hand, the antenna switch 2 transmits the CATV broadcast signal S11 to the low distortion attenuator 22.

The low distortion attenuator 22 attenuates the CATV broadcast signal S11 in accordance with an AGC control signal GS2 which is supplied from the demodulation circuit 5, and transmits the resulting CATV broadcast signal S12 to an input terminal 23B of the signal selector switch 23.

Here, if the control circuit 6 of the television broadcast signal receiver 3 receives a broadcast select signal SS1 for selecting a terrestrial television broadcast from the remote control, it transmits the broadcast select signal SS1 to the signal selector switch 23 of the antenna switch 2.

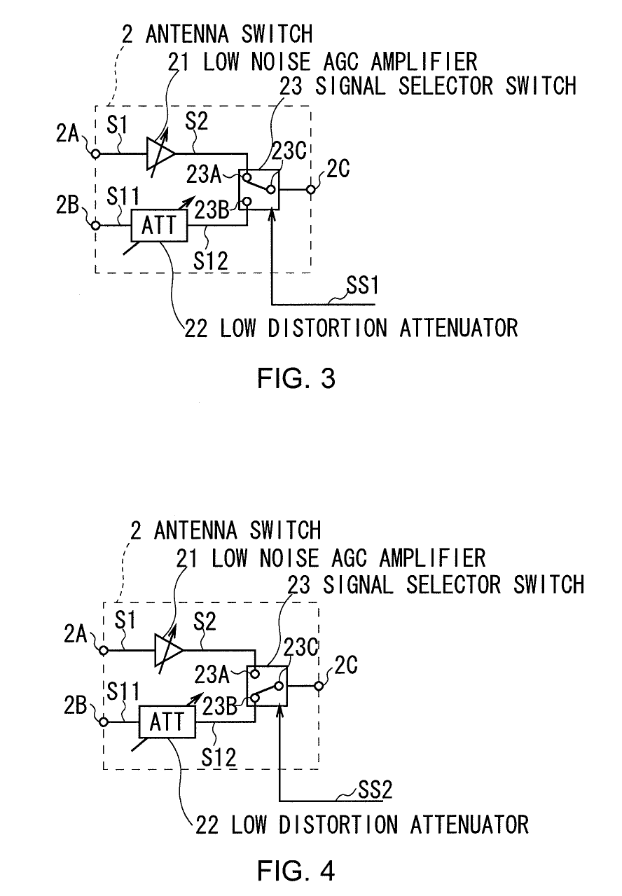

As shown in FIG. 3, the signal selector switch 23 of the antenna switch 2 electrically connects the input terminal 23A with the output terminal 23C when the broadcast select signal SS1 is supplied from the control circuit 6. As a result, the antenna switch 2 transmits the terrestrial television broadcast signal S2 to the tuner 4 through the input terminal 23A and the output terminal 23C of the signal selector switch 23 and the antenna switch output terminal 2C.

If the control circuit 6 of the television broadcast signal receiver 3 (FIG. 2) receives a broadcast select signal SS2 for selecting a CATV broadcast from the remote control, it transmits the broadcast select signal SS2 to the signal selector switch 23 of the antenna switch 2.

As shown in FIG. 4, the signal selector switch 23 electrically connects the input terminal 23B with the output terminal 23C when the broadcast select signal SS2 is supplied from the control circuit 6. As a result, the antenna switch 2 transmits the CATV broadcast signal S12 to the tuner 4 through the input terminal 23B and the output terminal 23C of the signal selector switch 23 and the antenna switch output terminal 2C.

Then, the antenna switch 2 (FIG. 2) only has the user select either one of a terrestrial television broadcast and a CATV broadcast by a remote control operation, and the broadcast select signal SS1 or SS2 corresponding to the selecting operation is supplied from the remote control to the signal selector switch 23 through the control circuit 6. The antenna switch 2 can feed the terrestrial television broadcast signal S2 or the CATV broadcast signal S12 to the tuner 4 by switching the signal selector switch 23 according to the broadcast select signal SS1 or SS2.

For example, when the terrestrial television broadcast signal S2 fed from the antenna switch 2 is input through the tuner input terminal 4A, the tuner 4 transmits the terrestrial television broadcast signal S2 to an input terminal 41A of the band selector switch 41.

If a channel select signal CS11 for selecting a desired channel in the very high frequency (VHF)—Low band of, e.g., 54 MHz to 170 MHz is supplied from the remote control, the control circuit 6 transmits the channel select signal CS11 to the band selector switch 41.

If a channel select signal CS12 for selecting a desired channel in the VHF-High band of, e.g., 170 MHz to 470 MHz is supplied from the remote control, the control circuit 6 transmits the channel select signal CS12 to the band selector switch 41.

If a channel select signal CS13 for selecting a desired channel in the ultra high frequency (UHF) band of, e.g., 470 MHz to 864 MHz is supplied from the remote control, the control circuit 6 transmits the channel select signal CS13 to the band selector switch 41.

The band selector switch 41 electrically connects the input terminal 41A with the output terminal 41B when the channel select signal CS11 is supplied from the control circuit 6. The band selector switch 41 thereby transmits the terrestrial television broadcast signal S2 fed from the antenna switch 2 to the tracking filter 42A.

The tracking filter 42A passes the terrestrial television broadcast signal S2 supplied from the band selector switch 41 only within a frequency band corresponding to the desired channel, and transmits the passed terrestrial television broadcast signal S3A to the RF amplifier 43A.

The RF amplifier 43A amplifies the terrestrial television broadcast signal S3A supplied from the tracking filter 42A according to an AGC control signal GS3 which is supplied from the demodulation circuit 5, and transmits the amplified terrestrial television broadcast signal S4A to the mixer 44.

The mixer 44 multiplies the terrestrial television broadcast signal S4A supplied from the RF amplifier 43A by a local frequency signal RS supplied from the local oscillator 45 for frequency conversion, and transmits the resulting IF signal S5A to the IF filter 47.

The PLL circuit 46 compares a reference signal which is supplied from the control circuit 6 and the local frequency signal RS which the local oscillator 45 currently supplies to the mixer 44, and controls the local oscillator 45 so as to correct an error therebetween. The local oscillator 45 generates the local frequency signal RS according to the control of the PLL circuit 46, and transmits the local frequency signal RS to the mixer 44.

For band limitation, the IF filter 47 passes the IF signal S5A supplied from the mixer 44 only within a predetermined frequency band, and transmits the passed IF signal S6A to the IF amplifier 48.

The IF amplifier 48 amplifies the IF signal S6A supplied from the IF filter 47 to a predetermined signal level, and transmits the amplified IF signal S7A to the demodulation circuit 5.

Now, when the selection signal CS12 is supplied from the control circuit 6, the band selector switch 41 electrically connects the input terminal 41A with an output terminal 41C, whereby the terrestrial television broadcast signal S2 fed from the antenna switch 2 is transmitted to the tracking filter 42B.

The tracking filter 42B passes the terrestrial television broadcast signal S2 supplied from the band selector switch 41 only within a frequency band corresponding to a desired channel, and transmits the passed terrestrial television broadcast signal S3B to the RF amplifier 43B.

The RF amplifier 43B amplifies the terrestrial television broadcast signal S3B supplied from the tracking filter 42B according to an AGC control signal GS4 which is supplied from the demodulation circuit 5, and transmits the amplified terrestrial television broadcast signal S4B to the mixer 44.

The mixer 44, the IF filter 47, and the IF amplifier 48 subsequently operate as in the foregoing processing of the terrestrial television broadcast signal S4A. The mixer 44 multiplies the terrestrial television broadcast signal S4B supplied from the RF amplifier 43B by the local frequency signal RS supplied from the local oscillator 45 for frequency conversion, and transmits the resulting IF signal S5B to the IF filter 47.

For band limitation, the IF filter 47 passes the IF signal S5B supplied from the mixer 44 only within a predetermined frequency band, and transmits the passed IF signal S6B to the IF amplifier 48. The IF amplifier 48 amplifies the IF signal S6B, and transmits the resulting IF signal S7B to the demodulation circuit 5.

When the selection signal CS13 is supplied from the control circuit 6, the band selector switch 41 electrically connects the input terminal 41A with an output terminal 41D, whereby the terrestrial television broadcast signal S2 fed from the antenna switch 2 is transmitted to the tracking filter 42C.

The tracking filter 42C passes the terrestrial television broadcast signal S2 supplied from the band selector switch 41 only within a frequency band corresponding to a desired channel, and transmits the passed terrestrial television broadcast signal S3C to the RF amplifier 43C.

The RF amplifier 43C amplifies the terrestrial television broadcast signal S3C supplied from the tracking filter 42C according to an AGC control signal GS5 which is supplied from the demodulation circuit 5, and transmits the amplified terrestrial television broadcast signal S4C to the mixer 44.

The mixer 44, the IF filter 47, and the IF amplifier 48 subsequently operate as in the foregoing processing of the terrestrial television broadcast signal S4B. The mixer 44 multiplies the terrestrial television broadcast signal S4C supplied from the RF amplifier 43C by the local frequency signal RS supplied from the local oscillator 45 for frequency conversion, and transmits the resulting IF signal S5C to the IF filter 47.

For band limitation, the IF filter 47 passes the IF signal S5C supplied from the mixer 44 only within a predetermined frequency band, and transmits the passed IF signal S6C to the IF amplifier 48. The IF amplifier 48 amplifies the IF signal S6C, and transmits the resulting IF signal S7C to the demodulation circuit 5.

As above, the tuner 4 can supply the IF signal S7A, S7B, or S7C of a desired terrestrial television broadcast channel to the demodulation circuit 5 by only having the desired channel selected by a user's remote control operation.

Note that when the CATV broadcast signal S12 fed from the antenna switch 2 is input through the tuner input terminal 4A, the tuner 4 performs the same processing as when the terrestrial television broadcast signal S2 is input through the tuner input terminal 4A. Description will thus be omitted for convenience's sake.

### (1-3) Circuit Configuration of Low Noise AGC Amplifier

Next, the low noise AGC amplifier 21 will be described.

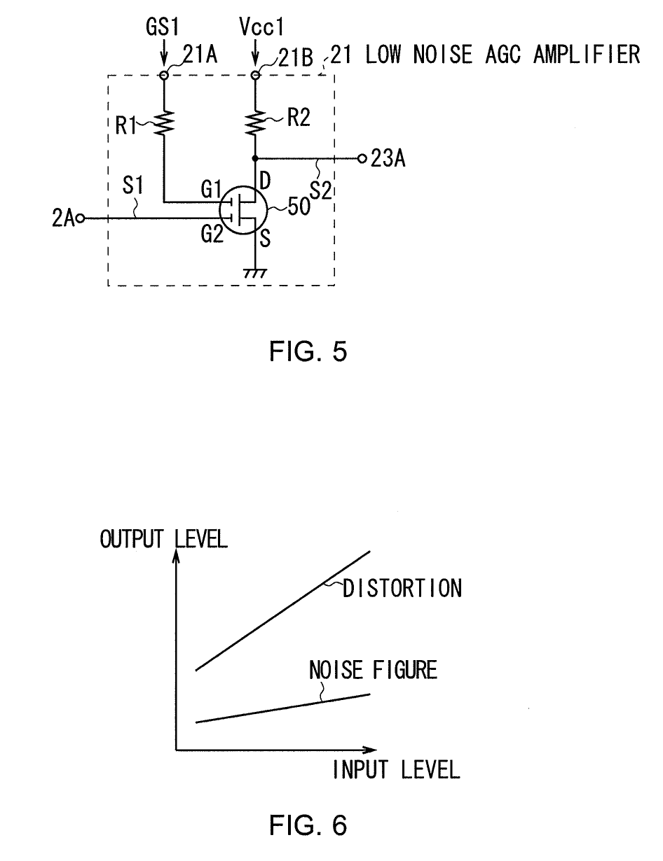

As shown in FIG. 5, the low noise AGC amplifier 21 is composed of resistors R1 and R2, and a dual gate field effect transistor (hereinafter, referred to as dual gate FET) 50.

In the low noise AGC amplifier 21, the AGC control signal GS1 is input to an input terminal 21A which is connected to a gate G1 of the dual gate FET 50 through the resistor R1. The terrestrial television broadcast signal input terminal 2A is connected to a gate G2 of the dual gate FET 50. A power supply voltage Vcc1 is supplied to an input terminal 21B which is connected to the drain D of the dual gate FET 50 through the resistor R2. The input terminal 23A of the signal selector switch 23 is connected to the junction between the resistor R2 and the drain D of the dual gate FET 50. The source S of the dual gate FET 50 is grounded.

The dual gate FET 50 of the low noise AGC amplifier 21 turns on when the terrestrial television broadcast signal S1 received by the antenna 7 is supplied to the gate G2 of the dual gate FET 50 through the terrestrial television broadcast signal input terminal 2A and the AGC control signal GS1 supplied from the control circuit 6 is supplied to the gate G1 of the dual gate FET 50 through the resistor R1. In the AGC amplifier 21, the voltage level at the drain D of the dual gate FET 50 is then amplified according to the AGC control signal GS1 and the terrestrial television broadcast signal S1, and the amplified voltage level is transmitted to the input terminal 23A of the signal selector switch 23 as the terrestrial television broadcast signal S2.

Having the foregoing configuration, the low noise AGC amplifier 21 has the property of causing little increase in noise figure regardless of the input level of the terrestrial television broadcast signal S1.

As employed herein, the noise figure refers to the ratio between the signal/noise (S/N) ratio of an input signal and the S/N ratio of an output signal. To this low noise AGC amplifier 21, the noise figure shall refer to the ratio between the S/N ratio of the terrestrial television broadcast signal S1 and that of the terrestrial television broadcast signal S2.

As shown in FIG. 6, the low noise AGC amplifier 21 can amplify the terrestrial television broadcast signal S1 received by the antenna 7 without causing any increase in noise figure regardless of the input level of the terrestrial television broadcast signal S1.

Note that the low noise AGC amplifier 21 increases distortion with the increasing input level of the terrestrial television broadcast signal S1. This hardly matters to the low noise AGC amplifier 21, however, since the terrestrial television broadcast signal S1 contains little distortion.

### (1-4) Circuit Configuration of Low Distortion Attenuator

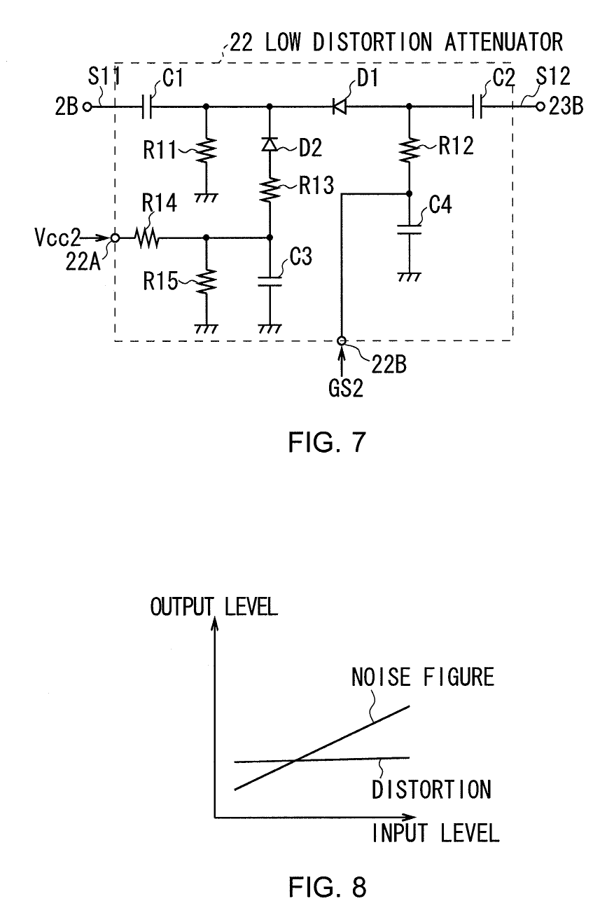

As shown in FIG. 7, the low distortion attenuator 22 is composed of DC blocking capacitors C1 and C2, bypass capacitors C3 and C4, PIN diodes D1 and D2, and resistors R11 to R15. The resistor R11, the PIN diode D1, and the resistor R12 constitute a attenuator.

The low distortion attenuator 22 has the CATV broadcast signal input terminal 2B to which the CATV broadcast signal S11 is input from the CATV cable 8. The CATV broadcast signal input terminal 2B and the input terminal 23B of the signal selector switch 23 are connected to each other through the DC blocking capacitor C1, the PIN diode D1, and the DC blocking capacitor D2. Specifically, the DC blocking capacitor C1 is interposed between the CATV broadcast signal input terminal 2B and the cathode of the PIN diode D1. The DC blocking capacitor C2 is interposed between the anode of the PIN diode D1 and the input terminal 23B.

The cathode of the PIN diode D1 is grounded through the resistor R11. A power supply voltage Vcc2 is supplied to an input terminal 22A which is connected to the cathode of the PIN diode D1 through the resistor R14, the resistor R13, and the PIN diode D2. Specifically, the cathode of the PIN diode D1 and the cathode of the PIN diode D2 are connected to each other. The resistor R15 is connected to the junction between the resistors R13 and R14.

The bypass capacitor C3 is also connected to the junction between the resistors R13 and R14 so as to be in parallel with the resistor R15. The bypass capacitor C3 and the resistor R15 are grounded. The AGC control signal GS2 is input to an input terminal 22B which is connected to the anode of the PIN diode D1 through the resistor R12. The bypass capacitor C4 is connected to the junction between the input terminal 22B and the resistor R12. The bypass capacitor C4 is grounded.

The power supply voltage Vcc2 is divided by the resistors R14 and R15, and the divided voltage is applied to the junction between the DC blocking capacitor C1 and the cathode of the PIN diode D1 through the resistor R13 and the PIN diode D2.

The AGC control signal GS2 is applied to the junction between the anode of the PIN diode D1 and the DC blocking capacitor C2 through the resistor R12.

The resistance of the PIN diode D1 varies with the intensity of the passing current. The low distortion attenuator 22 therefore controls the voltage difference between the anode and cathode of the PIN diode D1 according to the AGC control signal GS2 supplied from the control circuit 6, so that the intensity of the current passing through this PIN diode D1 is changed for resistance control.

In consequence, the low distortion attenuator 22 can attenuate the CATV broadcast signal S11 input through the CATV broadcast signal input terminal 2B to a certain output level according to the AGC control signal GS2 supplied from the control circuit 6, and transmit the attenuated CATV broadcast signal S12 to the signal selector switch 23B.

Having the foregoing configuration, the low distortion attenuator 22 has the property of hardly increasing the distortion of the CATV broadcast signal S12 when attenuating the CATV broadcast signal S11 into the same, regardless of the input level of the CATV broadcast signal S11.

As shown in FIG. 8, the low distortion attenuator 22 can attenuate the CATV broadcast signal S11 which is input through the CATV cable 8, without causing any increase in distortion regardless of the input level of the CATV broadcast signal S11.

Note that the low distortion attenuator 22 increases noise figure with the increasing input level of the CATV broadcast signal S11. However, this hardly matters to the low distortion attenuator 22 since the CATV broadcast signal S11 has high input level.

### (2) Operation and Effect

In the foregoing configuration, the antenna switch 2 has the terrestrial television broadcast signal input terminal 2A for the terrestrial television broadcast signal S1 to be input to and the CATV broadcast signal input terminal 2B for the CATV broadcast signal S11 to be input to as its input terminals, and the antenna switch output terminal 2C as its output terminal.

The antenna switch 2 also includes the signal selector switch 23 which switches connection to either between the terrestrial television broadcast signal input terminal 2A and the antenna switch output terminal 2C or between the CATV broadcast signal input terminal 2B and the antenna switch output terminal 2C.

The antenna switch 2 further includes the low noise AGC amplifier 21 which is interposed between the terrestrial television broadcast signal input terminal 2A and the signal selector switch 23, and the low distortion attenuator 22 which is interposed between the CATV broadcast signal input terminal 2B and the signal selector switch 23.

Consequently, the antenna switch 2 can amplify the terrestrial television broadcast signal S1 received through the antenna 7 by using the low noise AGC amplifier 21, and feed the amplified terrestrial television broadcast signal S2 to the tuner 4 through the antenna switch output terminal 2C. Since the terrestrial television broadcast signal S1 is amplified by the low noise AGC amplifier 21, the antenna switch 2 can feed the tuner 4 with the terrestrial television broadcast signal S2 having low noise.

The antenna switch 2 can also attenuate the CATV broadcast signal S11 received through the CATV cable 8 by using the low distortion attenuator 22, and feed the attenuated CATV broadcast signal S12 to the tuner 4 through the antenna switch output terminal 2C. Since the CATV broadcast signal S11 is amplified by the low distortion attenuator 22, the antenna switch 2 can feed the tuner 4 with the CATV broadcast signal S12 having low distortion.

The antenna switch 2 only has the user make a simple operation to select a terrestrial television broadcast or a CATV broadcast by remote control, and the broadcast select signal SS1 or SS2 is received through the control circuit 6. The antenna switch 2 can feed the terrestrial television broadcast signal S2 or the CATV broadcast signal S12 corresponding to the broadcast select signal SS1 or SS2 received, to the tuner 4 from the tuner input terminal 4A through the signal selector switch 23.

According to the foregoing configuration, the antenna switch 2 can feed the terrestrial television broadcast signal S2 of low noise to the tuner 4 when it is supplied with the broadcast select signal SS1, and can feed the CATV broadcast signal S12 of low distortion to the tuner 4 when it is supplied with the broadcast select signal SS2. The antenna switch 2 can thus feed the terrestrial television broadcast signal S2 of low noise or the CATV broadcast signal S12 of low distortion to the tuner 4 by only having the user select either a terrestrial television broadcast or a CATV broadcast by remote control without complicated switching operations. The absence of the need for switching operations allows improved usability.

### (3) Other Embodiments

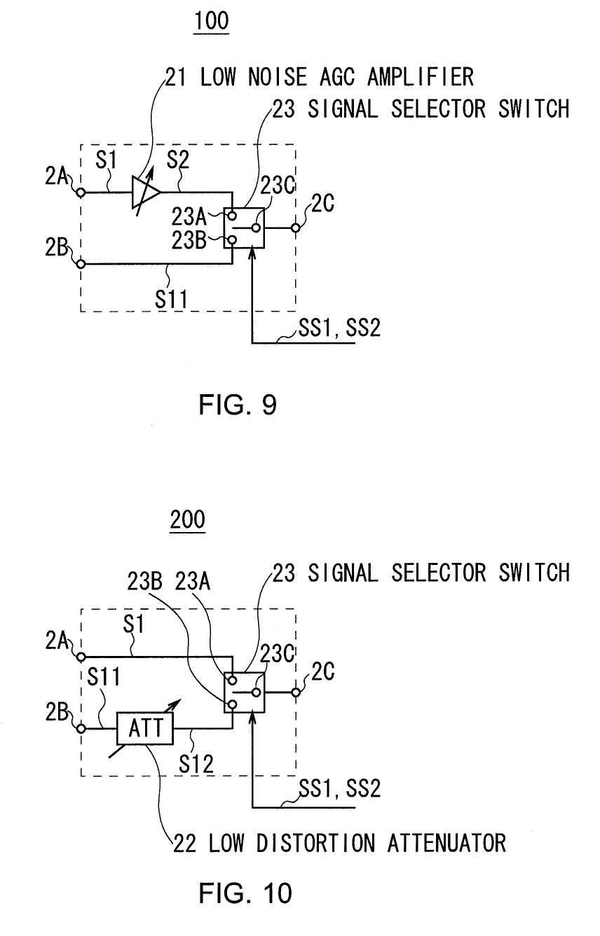

The foregoing embodiment has dealt with the case where the low noise AGC amplifier 21 is interposed between the terrestrial television broadcast signal input terminal 2A and the signal selector switch 23, and the low distortion attenuator 22 between the CATV broadcast signal input terminal 2B and the signal selector switch 23. The present invention is not limited thereto, however. As shown in FIG. 9 where corresponding parts to those of FIG. 2 are designated by like reference numerals, an antenna switch 100 may only have the low noise AGC amplifier 21 between the terrestrial television broadcast signal input terminal 2A and the signal selector switch 23 if the tuner 4 has a built-in low distortion attenuator beforehand.

While the foregoing embodiment has dealt with the case where the low noise AGC amplifier 21 is interposed between the terrestrial television broadcast signal input terminal 2A and the signal selector switch 23, and the low distortion attenuator 22 between the CATV broadcast signal input terminal 2B and the signal selector switch 23, the present invention is not limited thereto. As shown in FIG. 10 where corresponding parts to those of FIG. 2 are designated by like reference numerals, an antenna switch 200 may only have the low distortion attenuator 22 between the CATV broadcast signal input terminal 2B and the signal selector switch 23 if the tuner 4 has a built-in low noise AGC amplifier beforehand.

The foregoing embodiment has also dealt with the case where the low noise AGC amplifier 21 amplifies the terrestrial television broadcast signal S1 according to the AGC control signal GS1 supplied from the control circuit 6. The present invention is not limited thereto, however. The terrestrial television broadcast signal S1 may be amplified by an amplifier that provides a constant amplification. The terrestrial television broadcast signal S1 may otherwise be amplified by an amplifier that switches between a plurality of gains based on the control of the control circuit 6.

The foregoing embodiment has also dealt with the case where the low distortion attenuator 22 attenuates the CATV broadcast signal S11 according to the AGC control signal GS2 supplied from the control circuit 6. The present invention is not limited thereto, however. The CATV broadcast signal S11 may be attenuated by an attenuator that provides a constant attenuation. The CATV broadcast signal S11 may otherwise be attenuated by an attenuator that switches between a plurality of gains based on the control of the control circuit 6.

The foregoing embodiment has also dealt with the case where the antenna switch and the tuner apparatus according to an embodiment of the present invention include the terrestrial television broadcast signal input terminal 2A as the first input terminal, the CATV broadcast signal input terminal 2B as the second input terminal, the antenna switch output terminal 2C as the output terminal, the signal selector switch 23 as the signal selector switch, the low noise AGC amplifier 21 as the amplifier, the low distortion attenuator 22 as the attenuator, the tuner 4 as the television tuner, the control circuit 6 as the control unit, and the demodulation circuit 5 as the demodulation unit. The present invention is not limited thereto, however. The antenna switch and the tuner apparatus may include a first input terminal, a second input terminal, an output terminal, a signal selector switch, an amplifier, an attenuator, a television tuner, a control unit, and a demodulation unit of various other configurations.

The antenna switch and the tuner apparatus according to an embodiment of the present invention may be applied, for example, to an antenna switch that feeds the tuner of a video tape recorder, a digital versatile disc (DVD) recorder, or the like aside from the antenna switch for feeding the tuner of a television set.

It should be understood by those skilled in the art that various modifications, combinations, sub-combinations and alterations may occur depending on design requirements and other factors insofar as they are within the scope of the appended claims or the equivalents thereof.

What is claimed is:

1. An antenna switch comprising:
a first input terminal that receives a terrestrial television broadcast signal as input;
a second input terminal that receives a community antenna television broadcast signal to be input;
an output terminal that outputs the terrestrial television broadcast signal and the community antenna television broadcast signal;
a signal selector switch that switches connection to either between the first input terminal and the output terminal or between the second input terminal and the output terminal in accordance with a switch select signal supplied from a predetermined control unit; and
an amplifier that amplifies the terrestrial television broadcast signal and is interposed between the first input terminal and the signal selector switch.

2. The antenna switch according to claim 1, comprising
an attenuator that attenuates the community antenna television broadcast signal and is interposed between the second input terminal and the signal selector switch aside from the amplifier.

3. The antenna switch according to claim 2, wherein
the amplifier amplifies the terrestrial television broadcast signal in accordance with a gain supplied from a demodulation unit of a television set connected to a subsequent stage of the antenna switch; and
the attenuator attenuates the community antenna television broadcast signal in accordance with the gain supplied from the demodulation unit.

4. An antenna switch comprising:
a first input terminal that receives a terrestrial television broadcast signal as input;
a second input terminal that receives a community antenna television broadcast signal as input;
an output terminal that outputs the terrestrial television broadcast signal and the community antenna television broadcast signal;
a signal selector switch that switches connection to either between the first input terminal and the output terminal or between the second input terminal and the output terminal in accordance with a switch select signal supplied from a predetermined control unit; and
an attenuator that attenuates the community antenna television broadcast signal and is interposed between the second input terminal and the signal selector switch.

5. The antenna switch according to claim 4, comprising
an amplifier that amplifies the terrestrial television broadcast signal and is interposed between the first input terminal and the signal selector switch aside from the attenuator.

6. A tuner apparatus comprising an antenna switch and a television tuner unit, wherein
the antenna switch including:
a first input terminal that receives a terrestrial television broadcast signal as input;
a second input terminal that receives a community antenna television broadcast signal as input;
an output terminal that outputs the terrestrial television broadcast signal and the community antenna television broadcast signal;
a signal selector switch that switches connection to either between the first input terminal and the output terminal or between the second input terminal and the output terminal in accordance with a switch select signal supplied from the television tuner unit; and
an amplifier that amplifies the terrestrial television broadcast signal and is interposed between the first input terminal and the signal selector switch; and
the television tuner unit including:
a television tuner that has an input terminal to which the terrestrial television broadcast signal and the community antenna television broadcast signal are input from the antenna switch;
a control unit that supplies the switch select signal to the signal selector switch of the antenna switch; and
a demodulation unit that demodulates the terrestrial television broadcast signal and the community antenna television broadcast signal fed from the television tuner.

7. A tuner apparatus comprising an antenna switch and a television tuner unit, wherein
the antenna switch including:
a first input terminal that receives a terrestrial television broadcast signal as input;
a second input terminal that receives a community antenna television broadcast signal as input;
an output terminal that outputs the terrestrial television broadcast signal and the community antenna television broadcast signal;
a signal selector switch that switches connection to either between the first input terminal and the output terminal or between the second input terminal and the output terminal in accordance with a switch select signal supplied from the television tuner unit; and
an attenuator that attenuates the community antenna television broadcast signal and is interposed between the second input terminal and the signal selector switch; and
the television tuner unit including:
a television tuner that has an input terminal to which the terrestrial television broadcast signal and the community antenna television broadcast signal are input from the antenna switch;
a control unit that supplies the switch select signal to the signal selector switch of the antenna switch; and
a demodulation unit that demodulates the terrestrial television broadcast signal and the community antenna television broadcast signal fed from the television tuner.
